(19) United States
(12) Patent Application Publication
(10) Pub. No.: US 2021/0173950 A1
(43) Pub. Date: Jun. 10, 2021

(54) DATA SHARING BETWEEN TRUSTED EXECUTION ENVIRONMENTS

(71) Applicant: TEEware Co., Ltd., Daejeon (KR)

(72) Inventors: Nohyun Kwak, Daejeon (KR); Yunjong Jeong, Daejeon (KR)

(21) Appl. No.: 17/111,620

(22) Filed: Dec. 4, 2020

(30) Foreign Application Priority Data
Dec. 6, 2019 (KR) 10-2019-0161845
Aug. 13, 2020 (KR) 10-2020-0101596

(51) Int. Cl. G06F 21/60; H04L 9/08; G06F 21/70; H04L 9/32; H04L 9/06

(52) U.S. Cl. CPC G06F 21/606; H04L 9/083; H04L 9/0894; G06F 2221/2149; H04L 9/3247; H04L 9/0827; H04L 9/0643; G06F 21/70

(57) ABSTRACT

Disclosed is a method of sharing data among multiple processing devices incorporating a trusted execution environment. The method may include receiving a data encryption key (DEK) from a management software communicating with multiple processing devices; encrypting the received DEK using a sealing key accessible within the trusted execution environment; storing the encrypted DEK within the storage of the processing device; decrypting, using the sealing key, the stored DEK in response to a data sharing request; encrypting the data to be protected and shared using the decrypted DEK; and storing the encrypted data in a shared storage apparatus.

### CROSS REFERENCE TO RELATED APPLICATION

This application claims priority under 35 U.S.C. § 119 to Korean Patent Application No. 10-2019-0161845 filed on Dec. 6, 2019, No. 10-2020-0101596 filed on Aug. 13, 2020, which is incorporated herein by reference in its entirety.

### BACKGROUND OF THE INVENTION

### 1. Technical Field

The following description relates to a technology for data sharing between trusted execution environments.

### 2. Description of the Related Art

A trusted execution environment (TEE) is a safe computing environment configured utilizing a specially enabled function incorporated within a processor (CPU). One of the core functions of the trusted execution environment is sealing. Sealing enables confidential information generated within a trusted execution environment to be stored safely and permanently. The principle for safely storing confidential information generated within the trusted execution environment is as follows. A sealing key is a special encryption key which is accessible only within the trusted execution environment. Such a sealing key is generated based on a unique value inherent to each processor. The generated sealing key can be accessed only within a trusted execution environment. If data is encrypted by the sealing key and stored on a disk, common programs cannot access the data because they cannot obtain the sealing key. Only programs within the trusted execution environment have access to the sealing key and thus can decrypt the data.

Programs within a trusted execution environment (TEE) are turned on or off and thus do not persistently store value in the memory. In contrast, if the sealing function is used it is very useful because data can be permanently stored in the storage area (e.g., disk) of the processing device protected by the sealing function.

However, because a sealing key is unique to each processor, data sealed in the trusted execution environment of one computer cannot be accessed or retrieved by the trusted execution environment of another computer

### SUMMARY OF THE INVENTION

Embodiments may provide a method of sharing data between trusted execution environment (TEE)-enabled processing devices. Specifically, embodiments may provide a method of safely transmitting data stored in memory within the trusted execution environment of one processing device, to the memory within the trusted execution environment of another processing device through the use of a shared storage apparatus.

Embodiments for a method of sharing data between processing devices incorporating a trusted execution environment may include:
A. receiving a data encryption key from a management software communicating with multiple processing devices;
B. encrypting the received data encryption key (DEK) using a sealing key accessible within the trusted execution environment and storing the encrypted DEK in a storage area within the processing device;
C. decrypting the stored DEK using the sealing key in response to a data sharing request;
D. using the decrypted DEK, encrypting the data to be protected and shared among different trusted execution environments; and
E. storing the aforementioned encrypted data in a shared storage apparatus.

The management software may generate the data encryption key (DEK), and may perform remote attestation on a processing device to which the generated data encryption key (DEK) is to be transmitted.

Receiving the data encryption key (DEK) may include the processor of the processing device calculating a hash value for the software and processor information being executed in the processing device, electronically signing the hash value using a key generated from a value inherent to the processor, transmitting the electronic signature to the management software, and the management software attesting the electronic signature received from the processor of the processing device.

Receiving the data encryption key (DEK) may include establishing a secure communication channel between the processing device and the management software when the attestation of the electronic signature is successful by the management software, and transmitting the DEK generated by the management software through the established secure communication channel.

Storing the data encryption key (DEK) may include generating a sealing key from a value inherent to the processor of the processing device, encrypting the received DEK using the sealing key, and storing the encrypted DEK in the storage area (e.g., disk) of the processing device.

Other processing devices may decrypt the encrypted data stored in the shared storage apparatus, using the data encryption keys (DEK) stored in each processing device.

A trusted execution environment (TEE)-enabled processing device for sharing data may include a memory, and a processor connected to the memory and configured to execute at least one instruction stored in the memory. The processor may be configured to receive a data encryption key (DEK) from a management software communicating with multiple processing devices; encrypt the received DEK using a sealing key accessible within the trusted execution environment; store the encrypted DEK within the storage space of the processing device; decrypt, using the sealing key, the stored DEK in response to a data sharing request; encrypt the data to be protected and shared using the decrypted DEK; and store the encrypted data in a shared storage apparatus.

The management software may generate the data encryption key (DEK), and may perform remote attestation on a processing device to which the data encryption key generated by the management software is to be transmitted. The processor may calculate a hash value for the software and processor information being executed in the processing device, electronically sign the hash value using a key generated from a value inherent to the processor, and transmit the electronic signature to the management software. The management software may perform attestation on the electronic signature received from the processor of the processing device.

The processor may be configured to establish a secure communication channel between the processing device and the management software when the attestation of the electronic signature is successful and to transmit the data encryption key (DEK) generated by the management software through the established secure communication channel.

The processor may be configured to generate a sealing key from a value inherent to the processor of the processing device, encrypt the received data encryption key (DEK) using the sealing key, and store the encrypted DEK within the storage (e.g., disk) of the processing device.

### BRIEF DESCRIPTION OF THE DRAWINGS

FIG. 1 is a diagram describing the elements of a processing device, according to an embodiment.

FIG. 2 is a diagram describing the elements for data sharing between processing devices, according to an embodiment.

FIG. 3 is a diagram describing a data sharing operation between trusted execution environments in the processing devices, according to an embodiment.

FIG. 4 is a diagram describing an operation of receiving a data encryption key (DEK) in the processing device, according to an embodiment.

FIG. 5 describes an operation of storing a data encryption key (DEK) in the processing device, according to an embodiment.

FIG. 6 is a diagram describing an operation of transmitting data from one processing device to another processing device, according to an embodiment.

FIG. 7 is a flowchart describing a method of sharing data between the trusted execution environments of multiple processing devices, according to an embodiment.

### DETAILED DESCRIPTION

Hereinafter, embodiments are described in detail with reference to the accompanying drawings.

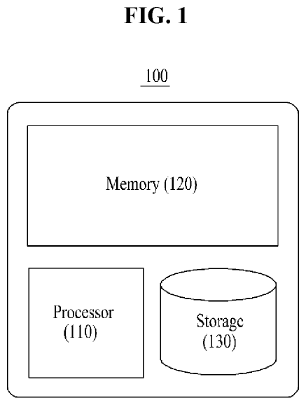

FIG. 1 is a diagram describing the elements of a processing device 100, according to an embodiment.

The processing device 100 is a processing device incorporating a trusted execution environment (TEE), and may share data with other trusted execution environments. The processing device 100 may include a processor 110, a memory 120, and a storage (e.g., disk) 130. The trusted execution environment (TEE) refers to a safe execution environment in which the integrity of a code is isolated from a common execution environment and the confidentiality of data generated and stored in the execution process are guaranteed. The trusted execution environment (TEE) is an advanced security technology in which the advantages of hardware and software are combined, providing security at a hardware level even though device-wise it is not detached hardware.

The processor 110 may control at least one element of the processing device 100 by executing a program in the memory 120. As such, the processor 110 may process data and/or perform operations. In this case, the processor 110 may execute an instruction stored in the memory 120.

The processor 110 is a device for executing a program. A unique value is physically engraved into each processor 110. It is difficult to extract this value (without physical access to the processor) because it is finely engraved and hidden within the circuit. The processor 110 may include a function for generating a child key based on this unique value in response to a request from a program running within a trusted execution environment.

The memory 120 may store various data used by at least one element of the processing device 100. For example, the memory 120 may include at least one of a volatile and/or a nonvolatile memory.

The storage 130 may represent any kind of non-volatile storage for storing information. For example, the storage 130 may correspond to a solid state drive, or a hard disk of a common computer or server, or network storage.

The processor 110 may receive a data encryption key (DEK) from a management software communicating with multiple processing devices. The processor 110 may encrypt the received DEK using a sealing key accessible within a trusted execution environment, and may store the encrypted DEK in the storage within the processing device. In response to a data sharing request, the processor 110 may decrypt the stored DEK using the sealing key. The processor 110 may encrypt data to be protected and shared using the decrypted DEK. The processor 110 may transmit and store the aforementioned encrypted data to a shared storage apparatus.

The memory 120 is a memory capable of reading and storing information, and may be a main memory of a computer or a volatile memory used for the temporary loading of an application program, the temporary storage of data, etc. The memory 120 may load a program and data being executed. The memory 120 may be encrypted by a unique key of the processor using a trusted execution environment function.

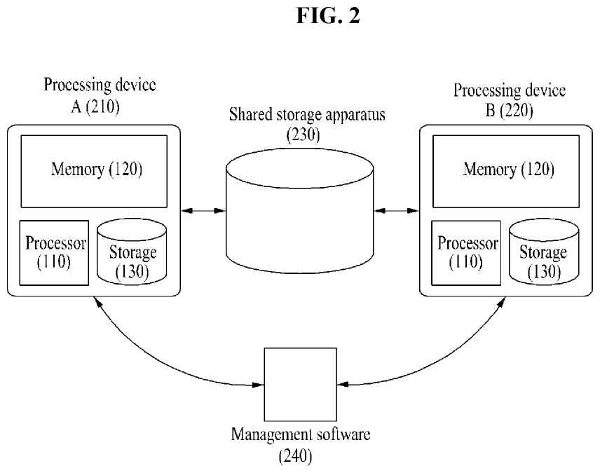

FIG. 2 is a diagram that describes the elements for data sharing between processing devices, according to an embodiment.

FIG. 2 describes the elements necessary to perform data sharing between the trusted execution environments of multiple processing devices. In an embodiment, “processing device A 210” and “processing device B 220”, are illustrated as examples of multiple processing devices.

Processing device A 210 may be a device that seeks to generate data within a trusted execution environment and transmit the data to another processing device (e.g., processing device B 220).

Processing device B 220 may be a device that seeks to receive within its trusted execution environment data generated by the processing device A 210.

A shared storage apparatus 230 may be a storage device which may be accessed by multiple processing devices (in an embodiment, the processing devices A 210 and B 220). For example, a database, a file system, or a file sharing server may correspond to a shared storage apparatus 230.

Management software 240 is software for verifying the integrity of multiple processing devices (in an embodiment, the processing devices A 210, B 220) and injecting a common encryption key.

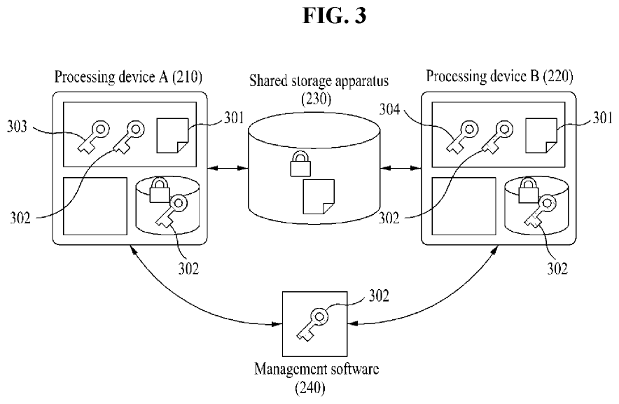

FIG. 3 is a diagram describing a data sharing operation between trusted execution environments of multiple processing devices, according to an embodiment.

First, the keys and the data to be protected and shared—as illustrated in the diagrams for each of the processing devices—are described.

Data 301 may be confidential data to be protected and safely transmitted from the trusted execution environment of processing device A 210 to the trusted execution environment of processing device B 220.

A data encryption key (DEK) 302 may be a key that encrypts the data to be shared. The DEK 302 may be generated by the management software 240.

The sealing keys 303 and 304 are keys generated from the unique value of the processor of each processing device, and may be used to permanently store, in a storage within the processing device, confidential data generated or used within the trusted execution environment. Accordingly, the sealing keys 303 and 304 each have different values corresponding to the processor of each processing device. For example, the sealing key 303 is generated from the unique value inherent to the processor of the processing device A 210; the sealing key 304 is generated from the unique value inherent to the processor of the processing device B 220.

The management software 240 may transmit the data encryption key (DEK) 302 to each of the processing devices (i.e., the processing devices A 210 and B 220) through a secure communication channel. Each of the processing devices (i.e., the processing devices A 210, B 220) may encrypt the DEK 302 using a sealing key generated from the value inherent to the processor of each processing device, and may store the encrypted DEK within the storage of each processing device. When the processing device A 210 stores data encrypted by the DEK in the shared storage apparatus 230, the processing device B 220 may retrieve the encrypted data from the shared storage apparatus 230. Thereafter, the processing device B 220 decrypts the data using the data encryption key stored in the processing device B 220, so that data sharing between trusted execution environments may be performed.

According to an embodiment, data stored in the memory of the trusted execution environment of processing device A 210 can be delivered, through the shared storage apparatus 230, to the memory within the trusted execution environment of processing device B 220. Data is encrypted while outside the trusted execution environment. Accordingly, the safe sharing of data can be conducted even in the case of a storage leakage or network eavesdropping attack.

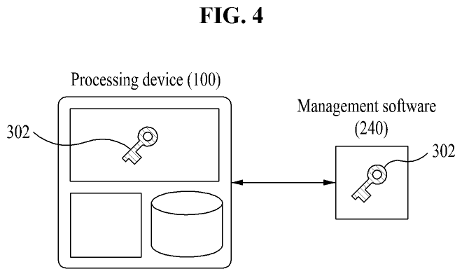

FIG. 4 is a diagram describing an operation of receiving a data encryption key by a processing device, according to an embodiment.

The processing device 100 may receive a data encryption key (DEK) 302 from the management software 240 communicating with multiple processing devices. A DEK 302 may be generated by the management software 240. Remote attestation may be performed on a processing device to which the DEK 302 generated by the management software 240 will be transmitted.

For the convenience of illustrating the operation of sharing data between multiple processing devices 100, processing devices A (210) and B (2002) are provided as examples. In this case, the processing device 100 may be a device for transmitting data (e.g., the processing device A) or a device for receiving data (e.g., the processing device B). In an embodiment, the processing device 100 is assumed to be the processing device A. For example, the processing device A may receive the data encryption key (DEK) 302 from a management software communicating with multiple processing devices. The DEK 302 may be generated by the management software 240. Remote attestation may be performed on the processing device A to which the DEK generated by the management software 240 will be transmitted.

Specifically, the processor of the processing device A may calculate a hash value for software and processor information being executed in the processing device A, and may electronically sign the hash value using a key generated from a value inherent to the processor. In this case, the key generated from the value inherent in the processor may be a sealing key or a different key. The processing device A may transmit the electronic signature to the management software 240. The management software 240 may attest the electronic signature received from the processor of the processing device A.

When the attestation of the electronic signature is successful by the management software 240, a secure communication channel between the processing device A and the management software 240 may be established. The data encryption key (DEK) 302 generated by the management software 240 may be transmitted to the processing device A through the established secure communication channel. The processing device A may receive the DEK 302 generated by the management software 240. As such, communication between the processing device A and management software (or application) can be minimized.

Likewise, the processing device B may receive the data encryption key (DEK) 302 from the management software communicating with multiple processing devices. The DEK 302 may be generated by the management software 240. Remote attestation may be performed on the processing device B to which the DEK generated by the management software 240 will be transmitted.

Specifically, the processor of the processing device B may calculate a hash value for software and processor information being executed in the processing device B, and may electronically sign the hash value using a key generated from a value inherent to the processor. The processing device B may transmit the electronic signature to the management software 240. The management software 240 may attest the electronic signature received from the processor of the processing device B.

When the attestation of the electronic signature is successful by the management software 240, a secure communication channel between the processing device B and the management software 240 may be established. The data encryption key (DEK) 302 generated by the management software 240 may be transmitted to the processing device B through the established secure communication channel. The processing device B may receive the DEK 302 generated by the management software 240.

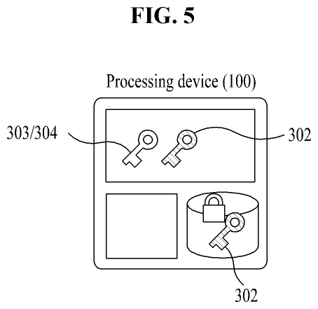

FIG. 5 describes an operation of storing a data encryption key (DEK) in the processing device, according to an embodiment.

The processing device 100 may store the data encryption key (DEK) 302. The processing device 100 may generate the sealing keys 303, 304 from a value inherent to the processors of each of processing devices, and may encrypt the DEK 302 using the generated sealing keys 303, 304. The processing device 100 may store the encrypted DEK 302 in the storage of the processing device.

For the convenience of illustrating the operation of sharing data between multiple processing devices 100, processing devices A (210) and B (2002) are provided as examples. In this case, the processing device 100 may be a device for transmitting data (e.g., the processing device A) or a device for receiving data (e.g., the processing device B). In an embodiment, the processing device 100 is assumed to be the processing device A.

For example, the processing device A may encrypt the received data encryption key (DEK) 302 using the sealing key 303 accessible within its trusted execution environment, and may store the encrypted DEK in the storage of the processing device A. In this case, the storage may be a disk.

The processing device A may generate the sealing key 303 from a value inherent to the processor of the processing device A. The processing device A may encrypt the data encryption key (DEK) 302, received from the management software 240, using the sealing key 303. The processing device A may store the encrypted DEK 302 in the storage of the processing device A.

Likewise, the processing device B may encrypt the received data encryption key (DEK) 302 using the sealing key 304 accessible within its trusted execution environment, and may store the encrypted DEK in the storage of the processing device B. In this case, the storage may be a disk.

The processing device B may generate the sealing key 304 from a value inherent to the processor of the processing device B. The processing device B may encrypt the data encryption key (DEK) 302 received from the management software 240, using the sealing key 304. The processing device B may store the encrypted DEK 302 in the storage of the processing device B.

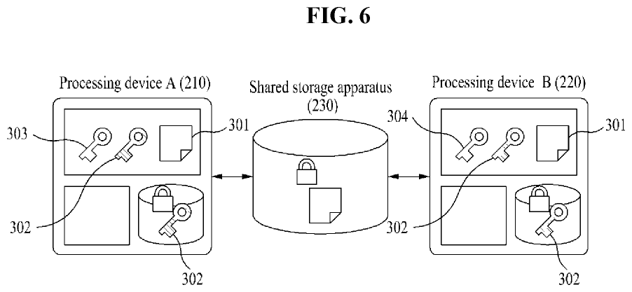

FIG. 6 is a diagram describing an operation of transmitting data from one processing device to another, according to an embodiment.

Data may be encrypted and transmitted from the trusted execution environment of one processing device to the trusted execution environment of another processing device. In an embodiment, an operation of sharing data, by the processing device A 210 with another processing device (e.g., the processing device B 220) is described.

The processing device A 210 may store, in the shared storage apparatus 230, data encrypted by the data encryption key (DEK) 302. In response to a data sharing request, the processing device A 210 may decrypt the DEK 302 stored in the storage of the processing device A 210, using the sealing key 303. The processing device A 210 may encrypt data 301 using the decrypted DEK 302. The processing device A 210 may store the encrypted data in the shared storage apparatus 230.

The processing device B 220 may retrieve the encrypted data from the shared storage apparatus 230. The processing device B 220 may decrypt the data 301 using the data encryption key (DEK) 302 stored in the processing device B 220. To decrypt the encrypted data retrieved from the shared storage apparatus 230, the processing device B 220 may decrypt the stored DEK 302 using the sealing key 304. The processing device B 220 may then decrypt the encrypted data retrieved from the shared storage apparatus 230, using the decrypted DEK 302. In this way, data can be shared between the trusted execution environment of the processing device A 210 and the trusted execution environment of the processing device B 220.

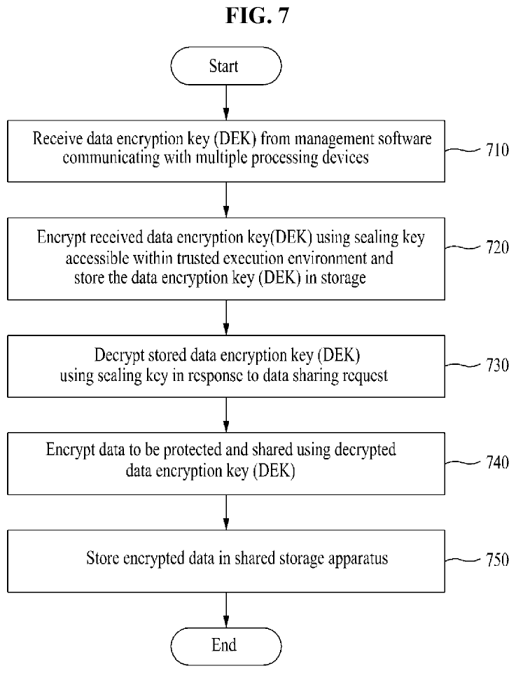

FIG. 7 is a flowchart describing a method of sharing data between trusted execution environments of multiple processing devices, according to an embodiment.

At step 710, the processing device may receive a data encryption key (DEK) from the management software communicating with multiple processing devices. In this case, the DEK may be generated by the management software, and remote attestation may be performed on a processing device to which the DEK generated by the management software will be transmitted. The processor of the processing device may calculate a hash value for the software and processor information being executed in the processing device, may electronically sign the hash value using a key generated from a value inherent to the processor, and may transmit the electronic signature to the management software. The management software may attest the electronic signature received from the processor of the processing device. When the attestation of the electronic signature is successful by the management software, a secure communication channel between the processing device and the management software is established. The processing device may receive the DEK generated by the management software through the established secure communication channel.

At step 720, the processing device may encrypt the received data encryption key (DEK) using a sealing key accessible within the trusted execution environment, and may store the DEK in the storage of the processing device. The processing device may generate a sealing key from a value inherent to the processor of the processing device, may encrypt the received DEK using the sealing key, and may store the encrypted DEK in the storage of the processing device.

At step 730, in response to a data sharing request, the processing device may decrypt the data encryption key (DEK) stored in the storage of the processing device, using the sealing key.

At step 740, the processing device may encrypt confidential data to be protected and shared using the decrypted DEK.

At step 750, the processing device may store the encrypted confidential data in the shared storage apparatus. In this case, the encrypted data stored in the shared storage may be decrypted by other processing devices using the DEK stored within each processing device.

The aforementioned apparatus (or device) may be implemented as a hardware component, a software component and/or a combination of both. For example, the apparatus and components described in the embodiments may be implemented using one or more general-purpose or special-purpose computers, including but not limited to: a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing device (or processor) may run an operating system (OS) and one or more software applications executed on the OS. Furthermore, the processing device may access, store, manipulate, process, and generate data in response to the execution of software. For convenience of understanding, one processing device has been depicted as being used, but a person having ordinary skill in the art may understand that the processing device may include a plurality of processing elements and/or a plurality of types of processing elements. For example, the processing device may include a plurality of processors or a single processor and a single controller. Furthermore, other processing configurations, such as a parallel processor, are also possible.

Software may include a computer program, code, an instruction or a combination of one or more of the aforementioned and may configure and control a processor so that it operates as desired or may instruct processors independently or collectively. The software and/or data may be embodied in any type of a machine, component, physical device, virtual equipment, or computer storage medium or device so as to be interpreted by the processor or to provide instruction or data to the processor. The software may be distributed to computer systems connected over a network and may be stored or executed in a distributed manner. The software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure alone or in combination. The program instructions stored in the medium may be specially designed and constructed for the present disclosure, or may be known and available to those skilled in the field of computer software. Examples of the computer-readable storage medium include magnetic media such as a hard disk, a floppy disk and a magnetic tape; optical media such as a CD-ROM and DVD; magneto-optical media such as a floptical disk; and hardware devices specially configured to store and execute program instructions such as a ROM, a RAM, and a flash memory. Examples of the program instructions include not only machine language code that is constructed by a compiler but also high-level language code that can be executed by a computer using an interpreter, or such intermediary.

Data can be encrypted and shared between the trusted execution environments of the respective processing devices.

Encrypted data stored in memory within the trusted execution environment of one processing device, through the shared storage, is transmitted to the memory within the trusted execution environment of another processing device. Data is encrypted while outside the trusted execution environment. Accordingly, the safe sharing of data can be conducted even in the case of a storage leakage or network eavesdropping attack.

As described above, although the embodiments have been described in connection with the limited examples and drawings, those skilled in the art may modify and change the embodiments in various ways from the description. For example, proper results may be achieved even if the above descriptions are performed in an order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and equivalents of the claims fall within the scope of the claims.

What is claimed is:

1. A method of sharing data among processing devices incorporating a trusted execution environment, the method comprising:
receiving a data encryption key (DEK) from a management software communicating with multiple processing devices;
encrypting the received data encryption key (DEK) using a sealing key accessible within the trusted execution environment and storing the data encryption key (DEK) within the storage of the processing device;
decrypting, using the sealing key, the stored data encryption key (DEK) in response to a data sharing request;
encrypting data to be protected and shared using the decrypted data encryption key (DEK); and
storing the encrypted data in a shared storage apparatus.

2. The method of claim 1, wherein the management software generates the data encryption key (DEK) and performs remote attestation on the processing device to which the generated data encryption key (DEK) is to be transmitted.

3. The method of claim 1, wherein receiving the data encryption key (DEK) comprises:
calculating, by a processor of the processing device, a hash value of the software and processor information being executed in the processing device by the processor of the processing device,
electronically signing the hash value using a key generated from a value inherent to the processor,
transmitting the electronic signature to the management software, and
attesting, by the management software, the electronic signature received from the processor of the processing device.

4. The method of claim 3, wherein receiving the data encryption key (DEK) comprises:
establishing a secure communication channel between the processing device and the management software when the management software successfully completes attestation of the electronic signature, and
transmitting the data encryption key (DEK) generated by the management software through the established secure communication channel.

5. The method of claim 1, wherein storing the encrypted data in the shared storage apparatus comprises:
generating a sealing key from a value inherent to the processor of the processing device,
encrypting the received data encryption key (DEK) using the sealing key, and
storing the encrypted data encryption key (DEK) in a storage within the processing device.

6. The method of claim 1, wherein the other processing devices decrypt the encrypted data, stored in the shared storage apparatus, by using the data encryption keys (DEKs) stored in each of the processing devices.

7. A processing device for sharing data incorporating a trusted execution environment, comprising:
a memory; and
a processor connected to the memory and configured to execute at least one instruction stored in the memory,
wherein the processor is configured to:
receive a data encryption key (DEK) from a management software communicating with multiple processing devices,
encrypt the received data encryption key (DEK) using a sealing key accessible within the trusted execution environment and store the encrypted data encryption key (DEK) in a storage within the processing device,
decrypt, using the sealing key, the stored data encryption key (DEK) in response to a data sharing request,
encrypt the data to be protected and shared using the decrypted data encryption key (DEK), and
store the encrypted data in a shared storage apparatus.

8. The processing device of claim 7, wherein:
the management software generates the data encryption key (DEK) and performs remote attestation on the processing device to which the data encryption key (DEK) generated by the management software is to be transmitted, and
when the processor calculates a hash value for the software and processor information being executed in the processing device, electronically signs the hash value using a key generated from a value inherent to the processor, transmits the electronic signature to the management software, and the management software attests the electronic signature received from the processor of the processing device.

9. The processing device of claim 8, wherein the processor is configured to:
establish a secure communication channel between the processing device and the management software when the attestation of the electronic signature is successful by the management software, and
transmit the data encryption key (DEK) generated by the management software through the established secure communication channel.

10. The processing device of claim 7, wherein the processor is configured to:
generate a sealing key from a value inherent to the processor of the processing device,
encrypt the received data encryption key (DEK) using the sealing key, and
store the encrypted data encryption key (DEK) within the storage of the processing device.
